(19) United States
(12) Patent Application Publication
(10) Pub. No.: US 2007/0087177 A1
(43) Pub. Date: Apr. 19, 2007

(54) Stacked pad and method of use

(76) Inventors: Guangwei Wu, Sunnyvale, CA (US); Steve Kirtley, Saratoga, CA (US); Thomas West, Portolla Valley, CA (US)

Correspondence Address: LARRY WILLIAMS, 3645 MONTGOMERY DR, SANTA ROSA, CA, 95405-5212, US

(21) Appl. No.: 10/575,028

(22) PCT Filed: Oct. 12, 2004
(86) PCT No.: PCT/US04/33591

§ 371 Date: Jun. 19, 2006

Related U.S. Application Data
(60) Provisional application No. 60/510,197, filed on Oct. 9, 2003.

(51) Int. Cl. B32B 7/02

(52) U.S. Cl. 428/218

(57) ABSTRACT

The following is a description of a stacked pad 15 for chemical mechanical polishing and/or planarizing substrates. In one embodiment, the stacked pad includes a top pad 20 and a subpad 40 where the modulus of the top pad 20 substantially equals the modulus of the subpad 40. Also presented are methods of using the stacked pad 15 which include methods of chemical mechanical polishing and/or planarization, and products of using the stacked pad.

### CROSS-REFERENCE

The present application claims benefit of U.S. patent application Ser. No. 60/510,197, filed Oct. 9, 2003. The present application is related to U.S. patent application Ser. No. 10/020,082, filed on 11 Dec. 2001 now Publication # US 2003-0100250A1. The contents of all of these applications are incorporated herein, in their entirety, by this reference.

### BACKGROUND

The present invention relates to stacked pads used for processing the surface of substrates such as for polishing substrates, cleaning substrates, and chemical mechanical polishing or planarization of substrates such as for the fabrication of electronic devices, and methods for using the stacked pads.

Electronic devices typically include a substrate, such as silicon or other types of semiconductor wafers, on which numerous integrated circuits have been formed. Integrated circuits are integrated into a substrate by patterning regions in the substrate and layers on the substrate. To achieve high yields, it is crucial to start with a substantially flat substrate; consequently, it is often necessary to planarize the substrate surface. For example, in fabricating modem semiconductor integrated circuits, it is necessary to form conductive lines or similar structures above a previously formed structure. However, prior surface formation often leaves the top surface topography of a wafer highly irregular, with bumps, areas of unequal elevation, troughs, trenches, and other similar types of surface irregularities. Global planarization of such surfaces is usually necessary.

Although several techniques exist for achieving substrate surface planarity, processes employing chemical mechanical planarization or polishing techniques have been widely used to planarize the surface of wafers during the various stages of device fabrication in order to improve yield, performance, and reliability. In general, chemical mechanical polishing (CMP) involves moving a wafer under a controlled pressure with pre-defined velocity over the surface of a polishing pad or a pad stack, while the surface may be covered or saturated with polishing slurry. Some processes involve moving a pad over a stationary substrate.

With the introduction of low dielectric constant materials, also referred to as low k materials, for integrated circuit manufacturing, a gentle process is preferred for CMP and polishing. Low down force or ultra-low down force chemical mechanical polish and/or electropolish have been used in the planarization of device wafers so as to maintain the integrity of low-k materials and porous low-k materials. In conventional approaches, a pad stack with a significantly softer sub-pad is used for polishing applications. The softer sub-pad is used to improve the conformability of the pad stack, therefore improved polishing uniformity.

In conventional applications, the polishing pad is broken-in before use to create a desired surface. The pad is also conditioned after each wafer polish either in-situ or ex-situ to maintain the pad surface or performance. The conditioning down force is relatively high for typical polishing applications. For example, the typical down force used in a 4″ (about 10 cm) diameter conditioner is 7-9 lb and ˜5 lb for polyurethane pads and polyurethane impregnated felt pads.

Descriptions of some stacked pad technologies can be found in the technical literature and patents such as U.S. Pat. No. 3,504,457 issued 7 Apr. 1970; U.S. Pat. No. 5,257,478 issued 2 Nov. 1993; U.S. Pat. No. 5,534,106 issued 9 Jul. 1996; U.S. Pat. No. 5,899,745 issued 4 May 1999; U.S. Pat. No. 5,944,583 issued 31 Aug. 1999; U.S. Pat. No. 6,267,659 issued 31 Jul. 2001; U.S. Pat. No. 6,379,216 issued 30 Apr. 2002; and U.S. Pat. No. 6,383,066 issued 7 May 2002. The content of all of these patents are incorporated herein by this reference.

Although stacked pads are in extensive use, a need remains for improved stacked pads which provide effective planarization across substrates such as those used for advanced electronic devices that include low dielectric constant materials for which less aggressive polishing and CMP processes are more suitable. More specifically, improved stacked pads are needed for use in processes that can polish or planarize electronic devices that include low dielectric constant materials without degrading the integrity of the low dielectric constant materials.

### SUMMARY

This invention pertains to stacked pads and to improved methods for using the stacked pads. Embodiments of the present invention seek to overcome one or more of the deficiencies of the standard technologies for planarization and/or polishing processes.

Yet, another aspect of the present invention includes electronic devices and other products made using the methods and apparatus disclosed herein.

It is to be understood that the invention is not limited in its application to the details of construction and to the arrangements of the components set forth in the following description or illustrated in the drawings. The invention is capable of other embodiments and of being practiced and carried out in various ways. In addition, it is to be understood that the phraseology and terminology employed herein are for the purpose of description and should not be regarded as limiting.

The above and still further features and advantages of the present invention will become apparent upon consideration of the following detailed descriptions of specific embodiments thereof, especially when taken in conjunction with the accompanying drawings.

### DESCRIPTION OF THE DRAWINGS

FIG. 1 is a cross sectional side view of an embodiment of the present invention.

FIG. 2 is a cross sectional side view of an embodiment of the present invention.

FIG. 3 is a side view diagram of an embodiment of the present invention.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DESCRIPTION

The operation of embodiments of the present invention will be discussed below, primarily in the context of polishing substrates such as substrates used for fabrication of electronic devices such as processing semiconductor wafers. However, it is to be understood that embodiments in accordance with the present invention are not limited to semiconductor wafer processing. In the following description of the figures, identical reference numerals have been used when designating substantially identical elements or steps that are common to the figures.

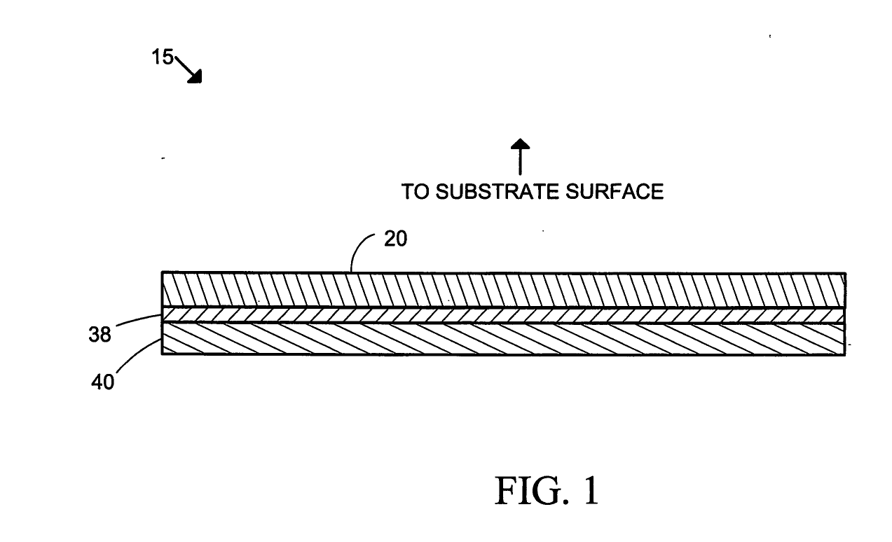

Reference is now made to FIG. 1 wherein there is shown a cross-section side view of a section of a stacked pad 15 according to one embodiment of the present invention. Stacked pad 15 includes a top pad 20 and a subpad 40. For some embodiments, an adhesive 38 is provided between the top pad 20 and subpad 40. Top pad 20 and subpad 40 can be made using a variety of techniques such as those typically used for making CMP polishing pads. Methods of making standard CMP polishing pads are well known in the technical and patent literature. For more information about polishing pads, see WIPO Publication No. W096/15887: the specification of which is incorporated herein by reference.

For applications that use stacked pad 15 for low down force polishing, the compression of sub-pad 40 is reduced, in comparison to standard polishing force processes. Conformability of sub-pad 40 becomes less effective in controlling the polishing uniformity. The structure of the pad and quality of the pad play a more important role in controlling the uniformity. Stacked pad 15 with a slightly softer sub-pad 40 or the same modulus sub-pad 40, compared to top pad 20, comprise a configuration for low down force and/or ultra-low down force polishing. As one embodiment of the present invention, polyurethane impregnated felt pads, such as Thomas West Inc.'s Hard Porous Pad described in U.S. patent application Ser. No. 10/020,082, filed on 11 Dec. 2001, and published as US 2003-0100250A1, is combined with a slightly softer sub-pad or the same modulus sub pad.

Table 1 summarizes several physical properties of some preferred embodiments of top pad 20 and subpad 40 suitable for embodiments of stacked pad 15 according to the present invention.

TABLE 1

| Property | Suitable | Preferred |
|---|---|---|
| Pad Density gm/cc | 0.5-0.7 | 0.58 +/− 0.04 |
| Fiber to Polymer Resin Ratio | 50:50-65:35 | 55:45 |
| Hardness, Shore D | >30 | 51-54 |
| Hardness, Shore A | | 89-98 |
| Felt Density gm/cc | | 0.32 |
| Pore Size Range um | | 5-150 |
| Compressibility % | | 1.8 |
| Resiliency % | 70-100 | >80 |

Conventional methods were used for measuring the properties of the pads.

More generally, for embodiments of the, present invention top pad 20 has Shore D hardness greater than about 30, preferably from about 40 to about 70 and all ranges and values subsumed therein. Similarly, subpad 40 has a preferred Shore D hardness from about 30 to about 70 and all ranges and values subsumed therein. More preferably, top pad 20 has Shore D hardness of about 50-60 and subpad 40 has Shore D hardness of about 50-60.

Another embodiment of the present invention is a method of chemical mechanical planarization that includes the step of using a stacked pad having a top pad that is slightly harder than the sub-pad or the same modulus as the subpad. For example a top pad having a hardness or modulus of 40-70 Shore D and the subpad having a slightly lower hardness or modulus of 30-60 Shore D.

During low down force or ultra-low down force polish, the alteration of the polishing surface of the top pad is insignificant. This is in contrast to standard downforce polishing. The conditioning of the pad between wafers polished becomes optional. In other words, the absence of significant alteration of the pad surface during ultra-low down force wafer polishing reduces and in some cases removes the need for conditioning the pad after polishing two or more wafers. Another embodiment of the present invention comprises a method of operating a CMP or planarization process or process tool for low or ultra low downforce polishing which includes processing a plurality of wafers between pad conditionings. More preferably, the method includes processing a multiplicity of wafers between pad conditionings. For some embodiments of the present invention, the method includes processing wafers with pad conditioning only before the first use of the pad. In other words, after the pad is broken-in, not further conditioning is performed.

Furthermore, the pad can be conditioned at very gentle down force (e.g. <3 lb for 4 inch (˜10 cm) diameter diamond disc) or conditioned after polishing multiple wafers. In other words, for some applications, embodiments of the present invention include the step of processing multiple wafers, such as five wafers between the step of conditioning the top pad; the process is then repeated where another multiple number of wafers, such as five wafers, are polished before the pad is conditioned again. For some embodiments of the present invention, more than five wafers are polished before conditionings.

One embodiment of the present invention includes a method of chemical mechanical planarization that includes providing a substrate having a surface for fabricating electronic devices. The surface includes a dielectric material having a dielectric constant less than two. The method also includes providing a stacked pad; the stacked pad includes a top pad having a Shore D hardness from about 40 to about 70 and a subpad having a Shore D hardness substantially equal to the hardness of the top pad. The method further includes contacting the top pad with the surface and planarizing the surface with the stacked pad. For some applications, the method further includes the step of conditioning the top pad using a down force less than about 0.24 psi (1.7 KPa); in other words, a low down force is used for conditioning the top pad. Preferably, the conditioning is performed using a diamond conditioner.

For some applications of the method, the step of conditioning the top pad is performed after planarization of a plurality of the substrates and performing the conditioning using a down force less than about 0.24 psi (1.7 KPa). For some embodiments of the present invention, five planarization steps are performed between each of the steps of conditioning the top pad, and the conditioning is performed using a down force less than about 0.24 psi (1.7 KPa).

Embodiments of the present invention may include the step of conditioning the top pad only prior to the first planarization and using the stacked pad for planarizing a multiplicity of the substrates. In other words, for some applications, embodiments of the present invention include conditioning the top pad prior to the first planarization then using the stacked pad without additional conditioning steps throughout the service life of the stacked pad.

Optionally for some embodiments of the present invention, the first conditioning of the top pad is performed on a tool other than the process tool used for the polishing or planarization step. In other words, the pad is broken-in in a separate tool, such as during the manufacturing process for fabricating the pad. The pad that has been broken-in is installed on a polishing process tool and used immediately without further conditioning. The break-in process in the polishing tool is not required for these embodiments.

Another embodiment of the present invention is a method of polishing and/or chemical mechanical planarization of electronic devices that include new low dielectric constant materials such as porous low k dielectrics with k values being less than 2. The method includes the step of providing a stacked pad having a top pad and a subpad with the hardness or modulus of the top pad about equal to the hardness or modulus of the subpad. In another embodiment, the method includes the step of providing a stacked pad having a top pad having hardness or modulus slightly higher than the hardness or modulus of the subpad.

A preferred embodiment of the present invention includes a method of chemical mechanical planarization for applications such as low down force processing of substrates for fabricating electronic devices such as devices that use low dielectric constant materials. The method includes the steps of providing a substrate having a surface for fabricating electronic devices and providing a stacked pad. The stacked pad includes a top pad and a subpad, wherein the hardness or modulus of the top pad substantially equals the hardness or modulus of the subpad. The method further includes the step of contacting the top pad with the surface and planarizing the surface with the stacked pad. Preferably, the top pad has a compressibility of about 1.8%, and subpad has a compressibility of about 1.8%. Preferably, the top pad and subpad have a substantially equal density and the density is in the range from about 0.5 to about 0.7 grams/cc. Preferably, the top pad and subpad have a substantially equal pore size range and the pore size range is in the range from about 0.5 to about 0.7 grams/cc. Preferably, the top pad and subpad have a substantially equal density and the density is in the range from about 0.5 to about 0.7 grams/cc and the top pad and sub pad have substantially equal hardness and the Shore D hardness is greater than about 47. The method can be performed using an apparatus for chemical mechanical planarization such as a CMP process tool.

Another preferred embodiment includes a stacked pad for processing substrates for the fabrication of electronic devices. The stacked pad comprises a polyurethane impregnated felt top pad having Shore D hardness from about 51 to about 54, a polyurethane impregnated felt subpad having Shore D hardness equal to the hardness of the top pad, and an adhesive sandwiched between the top pad and the subpad to bind the top pad to the subpad. The top pad and the subpad have density of 0.58 +/−0.04, a fiber to polymer resin ratio of 55:45, a felt density of 0.32 grams/cc, and a compressibility of 1.8%, wherein the properties of the top pad are substantially uniform and the properties of the sub pad are substantially uniform.

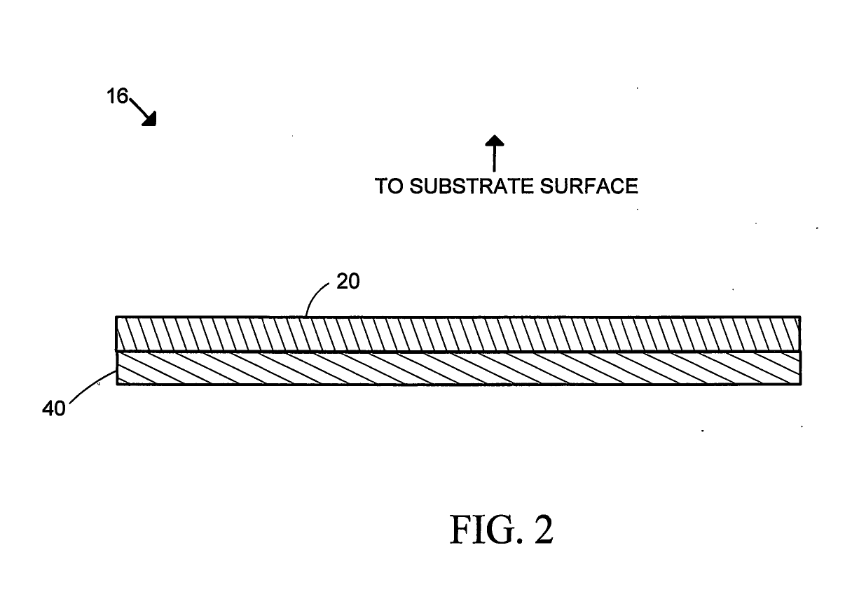

Reference is now made to FIG. 2 where there is shown a cross-section side view of a stacked pad 16 according to one embodiment of the present invention. Stacked pad 16 includes a top pad 20 and a subpad 40. Top pad 20 and subpad 40 are essentially the same as the top pad and subpad described for the embodiment shown in FIG. 1. In other words, the embodiment shown in FIG. 2 is essentially the same as that shown in FIG. 1 with the exception that an adhesive is not included in the embodiment of FIG. 2. It will be clear to those of ordinary skill in the art that top pad 20 and subpad 40 may be coupled using methods other than using an adhesive.

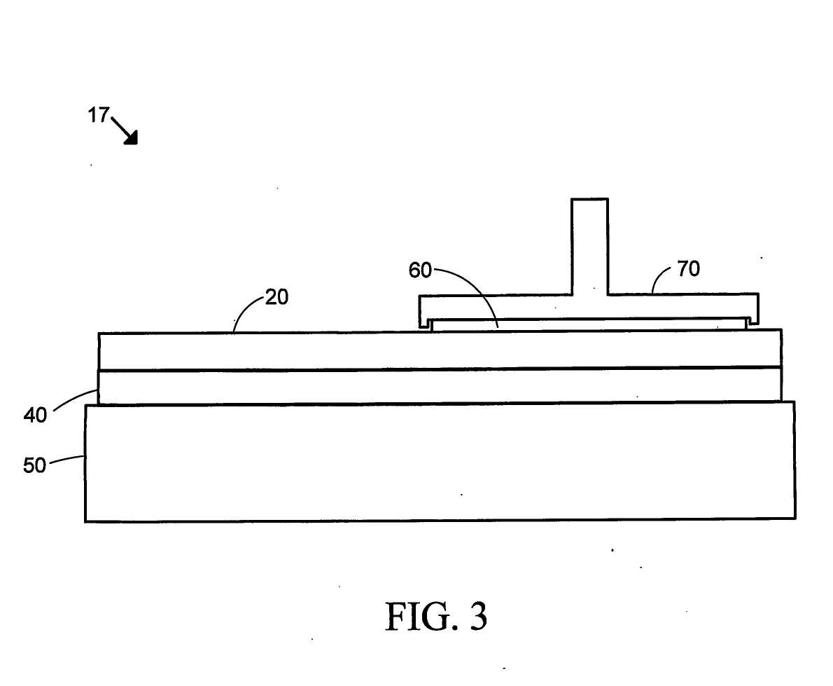

Reference is now made to FIG. 3 where there is shown another embodiment of the present invention. FIG. 3 presents a side view of an apparatus 17 for polishing the surface of a substrate. Apparatus 17 includes a top pad 20 and a subpad 40 forming a stacked pad. Top pad 20 and subpad 40 are essentially the same as the top pad and the subpad described for the embodiment shown in FIG. 1. Apparatus 17 includes a platen or other support for the pads. The embodiment in FIG. 3 shows a portion of a platen 50 for supporting subpad 40 and top pad 20. For illustration purposes, a silicon wafer 60 having a surface to be polished is shown contacting top pad 20. Apparatus 17 further includes a wafer carrier 70 for holding wafer 60 in contact with top pad 20.

Apparatus 17 illustrates a possible configuration for a polishing tool or process tool for polishing a substrate such as a wafer. It is to be understood that other configurations of the process tool can be used with the stacked pads as described in FIG. 1 and FIG. 2.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims.

As used herein, the terms “comprises,” “comprising,” “includes,” “including,” “has,” “having,” “at least one of,” or any other variation thereof, are intended to cover a non-exclusive inclusion. For example, a process, method, article, or apparatus that comprises a list of elements is not necessarily limited only to those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

What is claimed is:

1. A stacked pad for processing substrates for the fabrication of electronic devices, the stacked pad comprising a top pad having a Shore D hardness greater than or equal to about 40 and a subpad having a Shore D hardness substantially equal to the hardness of the top pad.

2. The stacked pad of claim 1, wherein the top pad has a Shore D hardness from about 40 to about 70 and all ranges and values subsumed therein.

3. The stacked pad of claim 1, wherein the top pad has a Shore D hardness from about 50 to about 60 and all ranges and values subsumed therein.

4. A stacked pad for processing substrates for the fabrication of electronic devices, the stacked pad comprising a top pad having a Shore D hardness from about 40 to about 70, a subpad having a Shore D hardness equal to the hardness of the top pad, and an adhesive sandwiched between the top pad and the subpad to bind the top pad to the subpad.

5. A method of chemical mechanical polishing, the method comprising the steps of:
A. providing a substrate having a surface for fabricating electronic devices, the surface comprising a dielectric material having a dielectric constant less than two;
B. providing a stacked pad, the stacked pad comprising a top pad having a Shore D hardness from about 40 to about 70 and a subpad having a Shore D hardness substantially equal to the hardness of the top pad; and
C. contacting the top pad with the surface and planarizing the surface with the stacked pad.

6. The method of claim 5 further comprising the step of conditioning the top pad using a down force less than about 0.24 psi (1.7 KPa).

7. The method of claim 5 further comprising the step of conditioning the top pad after planarization of a plurality of the substrates and performing the conditioning using a down force less than about 0.24 psi (1.7 KPa).

8. The method of claim 5 further comprising the step of planarization of five of the substrates before conditioning the top pad and performing the conditioning using a down force less than about 0.24 psi (1.7 KPa).

9. The method of claim 5 further comprising the step of repeating step A through step C a plurality of times before conditioning the top pad.

10. The method of claim 5 further comprising the step of repeating step A through step C a plurality of times before conditioning the top pad using a down force less than about 0.24 psi (1.7 KPa).

11. The method of claim 5 further comprising conditioning the top pad only prior to the first planarization and using the stacked pad for planarizing a multiplicity of the substrates.

12. The method of claim 5 further comprising processing a plurality of wafers between pad conditionings.

13. The method of claim 5, wherein the stacked pad is conditioned before the first planarization.

14. The method of claim 5, wherein the stacked pad is conditioned on a tool other than a polishing tool before the first planarization.

15. A method of chemical mechanical polishing, the method comprising the steps of:
A. providing a substrate having a surface for fabricating electronic devices;
B. providing a stacked pad, the stacked pad comprising a top pad and a subpad, wherein the hardness or modulus of the top pad substantially equals the hardness or modulus of the subpad; and
C. contacting the top pad with the surface and planarizing the surface with the stacked pad.

16. The method of claim 15, wherein the top pad and subpad have a compressibility of about 1.8%.

17. The method of claim 15, wherein the top pad and subpad have a substantially equal density and the density is in the range from about 0.5 to about 0.7 grams/cc.

18. The method of claim 15, wherein the top pad and subpad have a substantially equal pore size range and the pore size range is in the range from about 0.5 to about 0.7 grams/cc.

19. The method of claim 15, wherein the top pad and subpad have a substantially equal density and the density is in the range from about 0.5 to about 0.7 grams/cc and the top pad and sub pad have substantially equal hardness and the Shore D hardness is greater than about 47.

20. A stacked pad for processing substrates for the fabrication of electronic devices, the stacked pad comprising a polyurethane impregnated felt top pad having Shore D hardness from about 51 to about 54, a polyurethane impregnated felt subpad having Shore D hardness equal to the hardness of the top pad, and an adhesive sandwiched between the top pad and the subpad to bind the top pad to the subpad; the top pad and the subpad having density of 0.58 +/−0.04, a fiber to polymer resin ratio of 55:45, a felt density of 0.32 grams/cc, and a compressibility of 1.8%, wherein the properties of the top pad are substantially uniform and the properties of the sub pad are substantially uniform.
